(19) United States
(12) Patent Application Publication
(10) Pub. No.: US 2005/0125242 A1
(43) Pub. Date: Jun. 9, 2005

(54) Golf course management system

(76) Inventor: Rodney H. Butler, Redondo Beach, CA (US)

Correspondence Address: Irving Keschner, Suite 1150, 21515 Hawthorne Boulevard, Torrance, CA, 90503, US

(21) Appl. No.: 10/729,770

(22) Filed: Dec. 8, 2003

(51) Int. Cl. G06F 17/60

(52) U.S. Cl. 705/1; 705/9

(57) ABSTRACT

A system for lowering a golfers score on a given course by analyzing the strengths and weaknesses of each hole and adopting a strategy to fit the golfers game and style of play that maximizes the opportunities to score well. A multi-sheet booklet, or pad, is provided that allows a golfer to enter various data regarding a hole as it is being played. As the golfer is waiting to tee off, each hole is sketched using specific symbols, the club choice is noted, and the approximate yardage and location after each shot is marked on the designated page. In addition, various features of the hole are also noted such as water and sand traps, dog legs, tree location and for example, the surface contour of the green. After the round, the golfer can review the data entry for each hole and plan strategy for the next time the course is played.

### BACKGROUND OF THE INVENTION

1. Field of the Invention

The present invention provides a system for allowing a golfer to keep accurate records of his/her play on every course hole such that the golfer can compensate for course characteristics and lower his/her score when the course is played again.

2. Description of the Prior Art

Numerous items to improve a golfer's score having long been publicly available. Such items include books, videos, golf clubs, golf balls, devices for improving the golf swing, and so on. Whether these items have helped a golfer to consistently lower his/her score is open for debate.

Each golf course has its own specific characteristics and features. For example, sand traps and other obstacles are positioned at various places along a hole, the path to a hole on a green varies as to distance and location, the green itself may slope at different places etc.

A typical golfer plays the course, records a score and leaves to return to play another day. Although the person may remember some details of the course, many other details are forgotten. In addition, if a friend who has never played that course is invited to do so, the friend obviously will have no knowledge of the course characteristics.

What is desired is to provide a system for recording the characteristics of a golf course so that the golfer will have a permanent record thereof to help reduce his/her score the next time the course is played and, in addition, to make it available to golfers playing the course the first time so that these golfers will be familiar with the course layout before playing a particular hole.

### SUMMARY OF THE INVENTION

The present invention provides a system for lowering golf scores on a given course by analyzing the strengths and weaknesses of each hole and adopting a strategy to fit the golfers game and style of play that maximizes the opportunities to score well.

Specifically, a multiple page booklet, or pad, is provided that allows a golfer to enter various data regarding a hole as it is being played. Specifically, as the golfer is waiting to tee off, each hole is sketched using specific symbols, the club choice is noted, and the approximate yardage and location after each shot is marked on a designated page. In addition, various features of the hole are also noted such as water and sand traps, dog legs, tree location and for example, the surface contour of the green. After the round, the golfer can review the data entry for each hole and plan strategy for the next time the course is played.

The present invention thus provides a easy-to-use format and cost effective technique for managing a golf course to enable a golfer to identify his/her best approach and retain that strategy round after round for that course.

### DESCRIPTION OF THE DRAWINGS

For a better understanding of the present invention as well as other objects and further features thereof reference is made to the following description which is to be read in conjunction with the accompanying drawing therein:

FIG. 1 depicts a page from the management system of the present invention illustrating printed symbols, or indicia, that are used on succeeding blank pages to describe the hole characteristics;

FIG. 2 depicts a blank page from the management system of the present invention for receiving certain data for a specific course;

FIG. 3 depicts a blank page from the management system of the present invention for receiving data entries to describe how a hole was played;

FIG. 4 depicts a blank page from the management system of the present invention for receiving data regarding a hole green; and

FIGS. 5 and 6 illustrate examples of how the pages shown in FIGS. 3 and 4, respectively, are completed by filling in the appropriate data.

### DESCRIPTION OF THE INVENTION

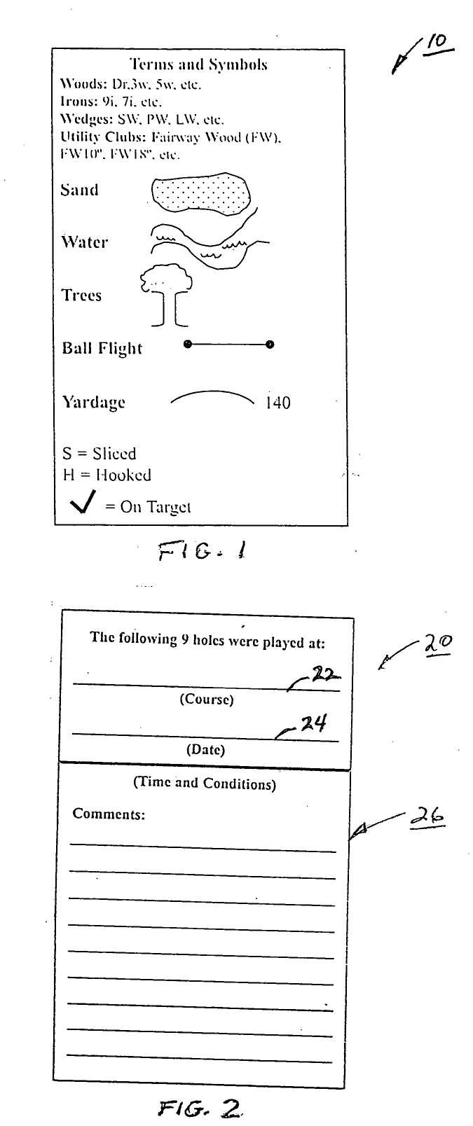

Referring now to FIG. 1, a first page, or sheet, 10 of a course management system pad or booklet of the present invention is illustrated. Page 10 has indicia printed thereon which sets forth the terms and symbols used in the management system. In particular, the terms include the clubs used by golfers under the heading Woods, Irons, Wedges and Utility Clubs. As illustrated, the clubs listed under the heading Woods includes Dr for a driver, 3w for a three wood, 5w for a five wood, etc. Under the heading Irons the clubs listed are 9i for a nine iron, 7i for a seven iron, etc. The clubs under the heading Wedges include SW for sand wedge, PW for a pitching wedge and LW for a lob wedge. The clubs under the heading Utility Clubs include FW for a fairway wood, FW10° for a ten degree fairway wood, FW18° for a eighteen degree fairway wood, etc.

Adjacent the term Sand is a symbol representing a sand trap, adjacent the term Water is a symbol representing a water hazard, adjacent the term Trees is a symbol representing trees, adjacent the term Ball Flight is a symbol representing the flight path of a hit golf ball and adjacent the term Yardage is a number symbol representing the length of the ball flight. Additional printed indicia include the letter S representing the term “Slice” indicating that the hit ball sliced (off to the right for a right handed golfer), the letter H representing the term “Hooked” indicating that the hit ball hooked (off to the left for a right handed golfer) and the check mark symbol indicating that the hit golf ball was on the desired path (or target).

FIG. 2 is the second page 20 in the course management system of the present invention. In particular, second page 20 has a line 22 to indicate where the golf game was played, a line 24 to indicate when the game was played and a page section 26 for entering comments regarding the course characteristics.

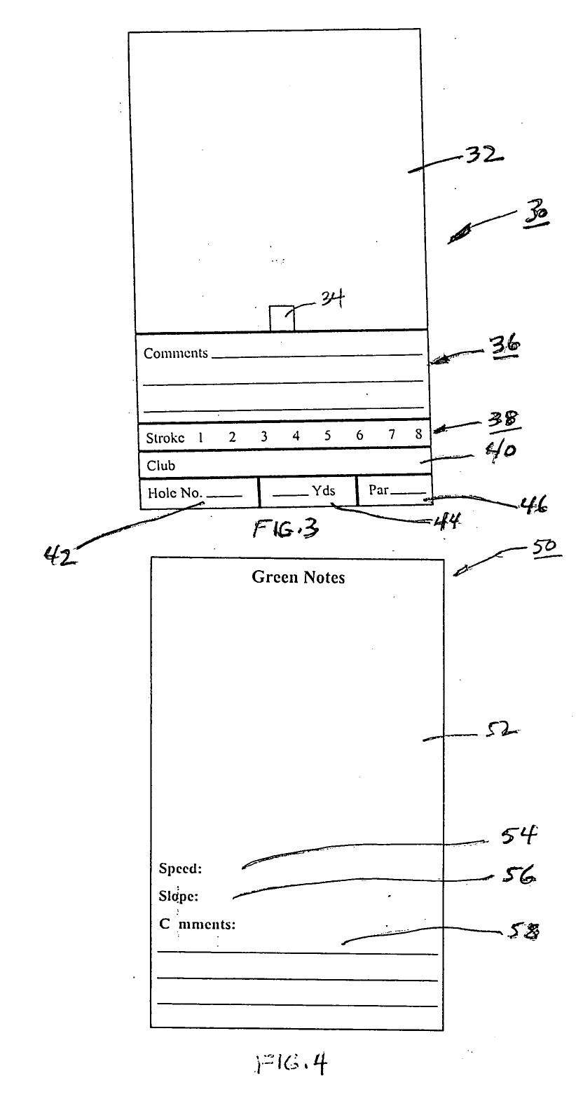

FIG. 3 is the third page 30 in the course management system of the present invention. In particular, page 30 has a section 32 for drawing in particulars about the hole being played, a symbol 34 representing the hole tee, a comments section 36 for entering comments about the hole being played, a section 38 wherein a golfer indicates the number of strokes (eight in the example illustrated since this is the upper “normal” number of strokes; numbers representing a higher number of strokes could be added) taken to complete the hole by marking the particular number, a section 40 for entering the symbol for the club used for each shot on the hole from the symbols shown in FIG. 1, a line 42 for entering the hole number being played, a section 44 for entering the length of the hole being played and a section 46 for inserting for the hole par.

FIG. 4 is the fourth page 50 in the course management system of the first invention for the green notes. Page 50 includes a blank screen 52 for inserting a representation of the hole green, a section 54 for entering an indication as to whether the green is considered fast, medium or slow, a section 56 for entering the slope contours of the green being played and a section 58 for entering specific comments about the green.

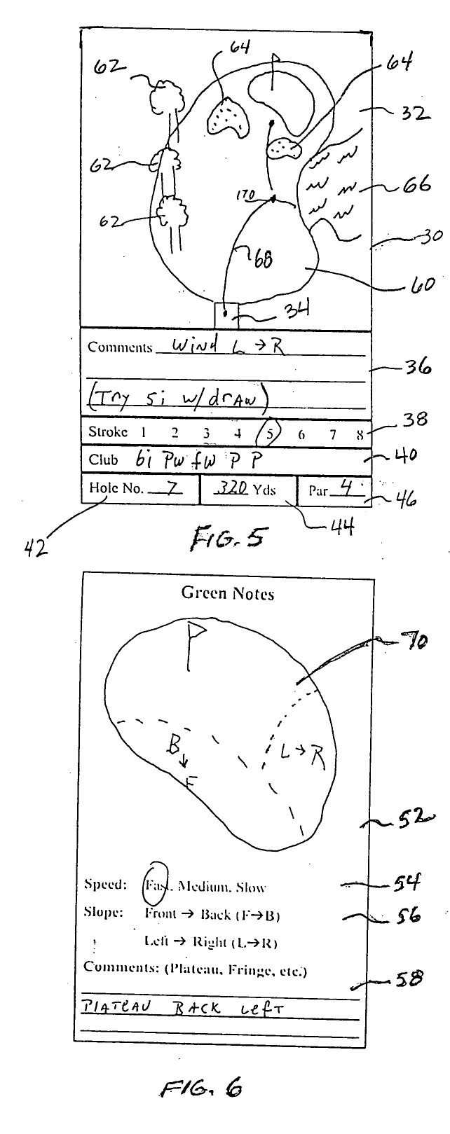

FIG. 5 is an example of a completed page 30 shown in FIG. 3. In particular, a hole 60 is drawn in, hole 60 having trees 62, sand traps 64 and water hazard 66. The first shot from tee 34 is represented by line 68, the shot going 170 yards. In the comments section 36, the player has indicated that the wind was blowing from left (L) to right (R) and that a five iron (5i) was used and the term “w/draw” described hereinbelow. In section 38, the player has noted that five strokes were used to play the hole; in section 40 the player indicates which club was used for each stroke (six iron, pitching wedge, flop wedge, putter, putter in sequence), section 42 indicates that hole 7 was played, section 44 indicates that the hole was 320 yards and section 46 indicates par was 4.

The page 30 illustrates a number of suggested terms that can be utilized and illustrates the flexibility an individual can apply to the system in order to adapt it to their own style of play and equipment. For example, the term “w/draw” means to try to hit the shot with a “draw” (or in other words a right to left movement for a right handed golfer as a future strategy. The flop wedge (“FW”) is a type of club that has extreme loft; since there are a wide variety of wedges available and more created all the time as club technology evolves, the term “FW” has been selected to illustrate a typical usage.

FIG. 6 is an example of a completed page 50 shown in FIG. 4. In particular, a green 70 is sketched in section 52. The right hand portion 72 of the green indicates the green slopes from left to right; the left hand portion 74 indicates that the green slopes from back to front. The speed of the green is noted as being fast. Finally, in the comments in section 58, the player has indicated that the green has a plateau on the back left portion of the green. The “back to front” and other associated terms related to green play are intended to allow the golfer to diagram the undulations of the green. The use of the dotted lines along with the terms provide a concise topography of the green so that when taken into consideration with the pin placement an advanced golfer could better target their approach shot. Thus, the term could apply to the edge of the green or to an indicated zone of the green. This system enables a golfer to easily diagram a complex set of undulations that even overlap in particular areas (i.e. both “front to back” and “left to right”).

It should be noted that the sample page shown in FIG. 6 includes a list of suggested terms that the golfer could choose from as would be appropriate for the green being played and has not been printed on the blank page shown in FIG. 4 for purposes of space conservation.

The course management system of the present invention thus provides a simple, relatively inexpensive system enabling a player to record the characteristics of a golf course so that the player has the ability to reduce his/her overall score on subsequent rounds at the golf course.

While the invention has been described with reference to its preferred embodiments, it will be understood by those skilled in the art that various changes may be made and equivalents may be substituted for elements thereof without departing from the true spirit and scope of the invention. In addition, many modifications may be made to adapt a particular situation or material to the teachings of the invention without departing from its essential teachings.

1. A golf course management system comprising a plurality of planar pages, a first of said pages having printed information relating to playing a particular golf course hole, a second of said selected pages having printed information relating to terms and symbols for playing a selected hole.

2. The management system of claim 1 wherein said terms include printed information representing the types of golf clubs used to play a course hole.

3. The management system of claim 1 wherein said symbols comprise printed information representing sand traps, water hazards and trees.

4. The management system of claim 3 wherein said symbols further include printed information representing, for a particular shot, the golf ball flight, the yardage a golf ball travels, whether the golf ball was sliced or hooked and whether the golf ball was on target.

5. The management system of claim 1 wherein a third page forming said system first and second surface sections formed thereon, printed information representing the course being played being formed in one of said sections and printed information representing player comments in said second section.

6. The management system of claim 1 wherein one of said selected planar pages has first, second, third, fourth and fifth surface sections formed by the printing of information thereon, first said surface sections having printed information representing a tee on a selected hole, said second section having printed information for comments about said selected hole, said third section having printed information representing the number of strokes taken for the selected hole, said fourth section having printed information representing the hole number being played and said section having printed information representing par for the selected hole.

7. The management system of claim 6 wherein another of said selected planar sheets has a plurality of surface sections formed by the printing of information thereon, one section having a blank area for inserting information relating to the hole green, a second section having printed information representing the ball speed on the green, a third section having printed information representing the slope of the green and a fourth section having printed information for comments on the green.
